(19) United States
(12) Patent Application Publication
(10) Pub. No.: US 2025/0218102 A1
(43) Pub. Date: Jul. 3, 2025

(54) HIGHER RADIX FAST FOURIER TRANSFORM IMPLEMENTATION ON GRAPHICS PROCESSING UNITS

(71) Applicant: QUALCOMM Incorporated, San Diego, CA (US)

(72) Inventors: Skyler SZOT, San Diego, CA (US); Hongqiang WANG, San Diego, CA (US); Alexander Lauson ANGUS, La Jolla, CA (US)

(21) Appl. No.: 18/399,564

(22) Filed: Dec. 28, 2023

(51) Int. Cl. G06T 15/00; G06F 9/38

(52) U.S. Cl. CPC G06T 15/005; G06F 9/3887

(57) ABSTRACT

Aspects presented herein relate to methods and devices for data or graphics processing including an apparatus, e.g., a GPU. The apparatus may allocate at least one data set in a plurality of data sets to at least one work item in a set of work items. The apparatus may also load the allocated at least one data set to a set of registers associated with the set of work items. Further, the apparatus may compute an operation for each of the set of registers based on the loaded at least one data set. The apparatus may also arrange an order of the at least one data set based on the computation of the operation for each of the set of registers. The apparatus may also store the at least one data set based on the arrangement of the order of the at least one data set.

### TECHNICAL FIELD

The present disclosure relates generally to processing systems and, more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor is configured to convert digital information received from a CPU to analog values and may issue commands to a display panel for displaying the visual content. A device that provides content for visual presentation on a display may utilize a GPU and/or a display processor.

A GPU of a device may be configured to perform the processes in a graphics processing pipeline. Further, a display processor or display processing unit (DPU) may be configured to perform the processes of display processing. However, with the advent of wireless communication and smaller, handheld devices, there has developed an increased need for improved graphics or display processing.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a graphics processing unit (GPU), a central processing unit (CPU), or any apparatus that may perform for graphics processing. The apparatus may obtain an indication of the at least one data set in the plurality of data sets, where the allocation of the at least one data set is based on the indication. The apparatus may also allocate at least one data set in a plurality of data sets to at least one work item in a set of work items. The apparatus may also load the allocated at least one data set to a set of registers associated with the set of work items. Additionally, the apparatus may compute an operation for each of the set of registers based on the loaded at least one data set. The apparatus may also arrange an order of the at least one data set based on the computation of the operation for each of the set of registers. Moreover, the apparatus may store the at least one data set based on the arrangement of the order of the at least one data set. The apparatus may also output an indication of the stored at least one data set based on the arrangement of the order of the at least one data set.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example content generation system.

FIG. 2 illustrates an example graphics processing unit (GPU).

FIG. 3 is a diagram illustrating example processing components.

FIG. 4 is a diagram illustrating an example GPU.

FIG. 5 is a diagram illustrating an example GPU.

FIG. 6 is a diagram illustrating an example of a Fourier transform.

FIG. 7 is a diagram illustrating an example butterfly diagram.

FIG. 8 is a diagram illustrating an example fast Fourier transform (FFT) implementation.

FIG. 9 is a diagram illustrating an example of FFT computation approaches.

FIG. 10 is a diagram illustrating an example of an FFT implementation.

FIG. 11 is a diagram illustrating an example of FFT implementation.

FIG. 12 is a communication flow diagram illustrating example communications between a GPU, a CPU/GPU, and a memory.

FIG. 13 is a flowchart of an example method of graphics processing.

FIG. 14 is a flowchart of an example method of graphics processing.

### DETAILED DESCRIPTION

In some aspects of graphics processing, it may be beneficial to optimize the fast Fourier transform (FFT) for certain components (e.g., a GPU). For example, some components (e.g., a digital signal processor (DSP)) may not be available to compute an FFT, so it may be beneficial to offload the FFT calculations to other components (e.g., a graphics processing unit (GPU)). Indeed, many FFT applications may utilize real-time execution speed, so it may be desirable to offload certain calculations (e.g., calculations associated with a radar processing pipeline) from one component (e.g., a DSP) to another component (e.g., a GPU). By doing so, this may free up the component (e.g., a DSP) for other calculations and/or tasks. In the context of FFT algorithms, a butterfly iteration is a portion of the computation that may combine the results of smaller discrete Fourier transforms (DFTs) into a larger DFT, or vice versa (e.g., breaking a larger DFT up into sub-transforms). Based on the above, it may be beneficial to offload FFT calculations from certain components (e.g., DSPs) to other components (e.g., a GPUs). Further, it may be beneficial to utilize a higher order of radix butterfly iteration for computing FFT calculations. Also, it may be beneficial to utilize consecutive butterfly iterations which may be merged for higher radix calculations. Aspects of the present disclosure may perform FFT calculations at certain components (e.g., GPUs), such as to offload FFT calculations from other components (e.g., DSPs). For instance, aspects of the present disclosure may free up certain components (e.g., DSPs) for other calculations and/or tasks by performing FFT calculations at certain components (e.g., GPUs). That is, aspects presented herein may optimize FFT algorithms for certain components (e.g., GPUs). Moreover, aspects presented herein may utilize an optimal FFT implementation that is hardware dependent at certain components (e.g., GPUs). Also, aspects presented herein may it may be beneficial to utilize a higher order of radix butterfly iteration for computing FFT calculations. Additionally, aspects presented herein may utilize consecutive butterfly iterations which may be merged for higher radix calculations.

Aspects of the present disclosure may include a number of benefits or advantages. For instance, aspects of the present disclosure may optimize FFT algorithms for certain components (e.g., GPUs). Moreover, aspects presented herein may utilize an optimal FFT implementation that is hardware dependent at certain components (e.g., GPUs). Also, aspects presented herein may it may be beneficial to utilize a higher order of radix butterfly iteration for computing FFT calculations. Additionally, aspects presented herein may utilize consecutive butterfly iterations which may be merged for higher radix calculations. Based on this, aspects of the present disclosure may execute FFT computations at an increased speed. That is, aspects presented herein may utilize a higher radix computation approach to execute the FFT computations on a GPU faster than any other FFT computation approach. Further, aspects presented herein may utilize a reduce amount of memory in order to execute the FFT computations. More precisely, aspects presented herein may utilize GPU registers to store FFT computations, rather than other GPU memory.

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software may be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

In general, this disclosure describes techniques for having a graphics processing pipeline in a single device or multiple devices, improving the rendering of graphical content, and/or reducing the load of a processing unit, i.e., any processing unit configured to perform one or more techniques described herein, such as a GPU. For example, this disclosure describes techniques for graphics processing in any device that utilizes graphics processing. Other example benefits are described throughout this disclosure.

As used herein, instances of the term “content” may refer to “graphical content,” “image,” and vice versa. This is true regardless of whether the terms are being used as an adjective, noun, or other parts of speech. In some examples, as used herein, the term “graphical content” may refer to a content produced by one or more processes of a graphics processing pipeline. In some examples, as used herein, the term “graphical content” may refer to a content produced by a processing unit configured to perform graphics processing. In some examples, as used herein, the term “graphical content” may refer to a content produced by a graphics processing unit.

In some examples, as used herein, the term “display content” may refer to content generated by a processing unit configured to perform displaying processing. In some examples, as used herein, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling, e.g., upscaling or downscaling, on a frame. In some examples, a frame may refer to a layer. In other examples, a frame may refer to two or more layers that have already been blended together to form the frame, i.e., the frame includes two or more layers, and the frame that includes two or more layers may subsequently be blended.

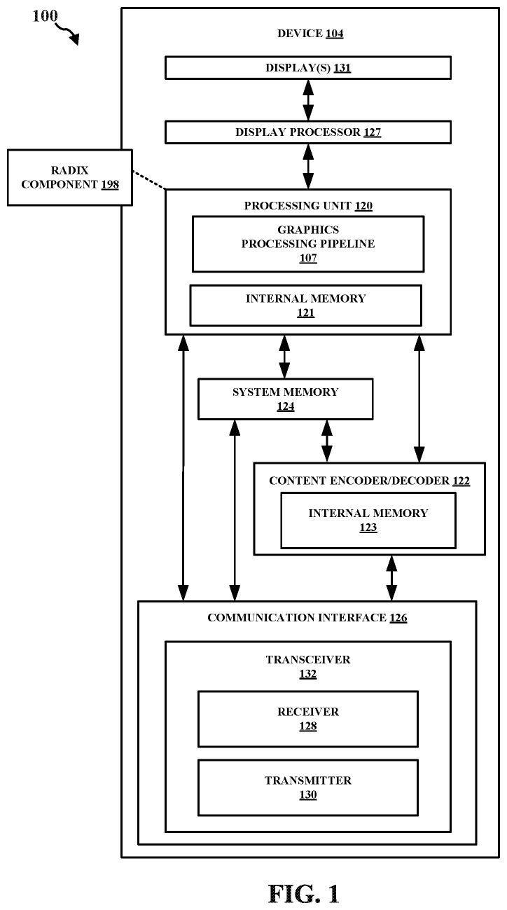

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of an SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components, e.g., a communication interface 126, a transceiver 132, a receiver 128, a transmitter 130, a display processor 127, and one or more displays 131. Reference to the display 131 may refer to the one or more displays 131. For example, the display 131 may include a single display or multiple displays. The display 131 may include a first display and a second display. The first display may be a left-eye display and the second display may be a right-eye display. In some examples, the first and second display may receive different frames for presentment thereon. In other examples, the first and second display may receive the same frames for presentment thereon. In further examples, the results of the graphics processing may not be displayed on the device, e.g., the first and second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing, such as in a graphics processing pipeline 107. The content encoder/decoder 122 may include an internal memory 123. In some examples, the device 104 may include a display processor, such as the display processor 127, to perform one or more display processing techniques on one or more frames generated by the processing unit 120 before presentment by the one or more displays 131. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 and the content encoder/decoder 122 may be communicatively coupled to the system memory 124 over a bus. In some examples, the processing unit 120 and the content encoder/decoder 122 may be communicatively coupled to each other over the bus or a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, SRAM, DRAM, erasable programmable ROM (EPROM), electrically erasable programmable ROM (EEPROM), flash memory, a magnetic data media or an optical storage media, or any other type of memory.

The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a central processing unit (CPU), a graphics processing unit (GPU), a general purpose GPU (GPGPU), or any other processing unit that may be configured to perform graphics processing. In some examples, the processing unit 120 may be integrated into a motherboard of the device 104. In some examples, the processing unit 120 may be present on a graphics card that is installed in a port in a motherboard of the device 104, or may be otherwise incorporated within a peripheral device configured to interoperate with the device 104. The processing unit 120 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a radix component 198 configured to obtain an indication of the at least one data set in the plurality of data sets, where the allocation of the at least one data set is based on the indication. The radix component 198 may also be configured to allocate at least one data set in a plurality of data sets to at least one work item in a set of work items. The radix component 198 may also be configured to load the allocated at least one data set to a set of registers associated with the set of work items. The radix component 198 may also be configured to compute an operation for each of the set of registers based on the loaded at least one data set. The radix component 198 may also be configured to arrange an order of the at least one data set based on the computation of the operation for each of the set of registers. The radix component 198 may also be configured to store the at least one data set based on the arrangement of the order of the at least one data set. The radix component 198 may also be configured to output an indication of the stored at least one data set based on the arrangement of the order of the at least one data set. Although the following description may be focused on display processing, the concepts described herein may be applicable to other similar processing techniques.

As described herein, a device, such as the device 104, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, a display or display device, a television, a television set-top box, an intermediate network device, a digital media player, a video streaming device, a content streaming device, an in-car computer, any mobile device, any device configured to generate graphical content, or any device configured to perform one or more techniques described herein. Processes herein may be described as performed by a particular component (e.g., a GPU), but, in further embodiments, may be performed using other components (e.g., a CPU), consistent with disclosed embodiments.

GPUs may process multiple types of data or data packets in a GPU pipeline. For instance, in some aspects, a GPU may process two types of data or data packets, e.g., context register packets and draw call data. A context register packet may be a set of global state information, e.g., information regarding a global register, shading program, or constant data, which may regulate how a graphics context will be processed. For example, context register packets may include information regarding a color format. In some aspects of context register packets, there may be a bit that indicates which workload belongs to a context register. Also, there may be multiple functions or programming running at the same time and/or in parallel. For example, functions or programming may describe a certain operation, e.g., the color mode or color format. Accordingly, a context register may define multiple states of a GPU.

Context states may be utilized to determine how an individual processing unit functions, e.g., a vertex fetcher (VFD), a vertex shader (VS), a shader processor, or a geometry processor, and/or in what mode the processing unit functions. In order to do so, GPUs may use context registers and programming data. In some aspects, a GPU may generate a workload, e.g., a vertex or pixel workload, in the pipeline based on the context register definition of a mode or state. Certain processing units, e.g., a VFD, may use these states to determine certain functions, e.g., how a vertex is assembled. As these modes or states may change, GPUs may need to change the corresponding context. Additionally, the workload that corresponds to the mode or state may follow the changing mode or state.

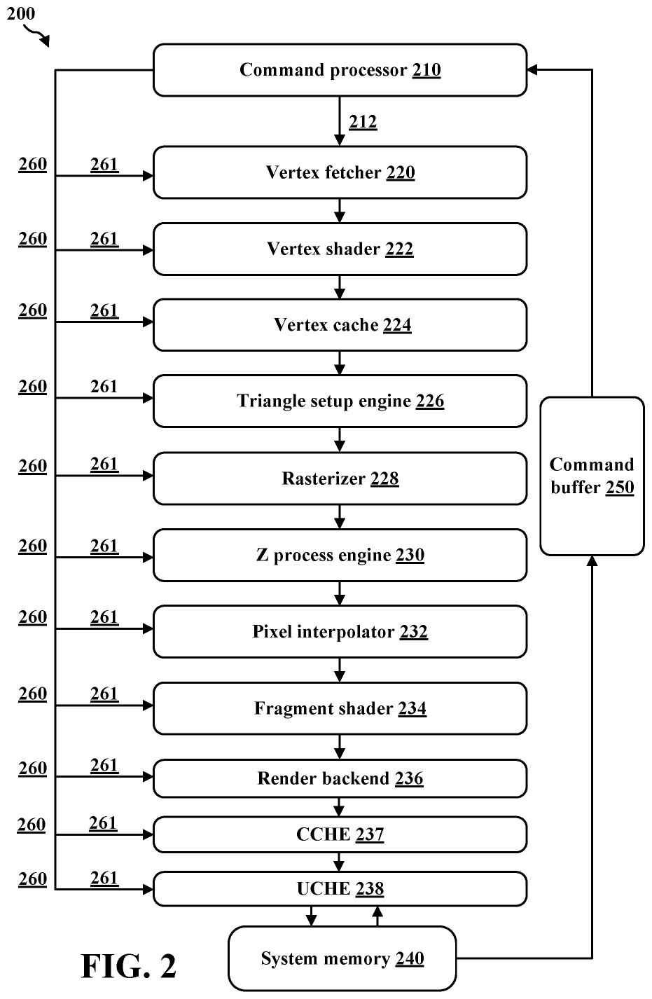

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, level 1 (L1) cache (cluster cache (CCHE)) 237, level 2 (L2) cache (UCHE) 238, and system memory 240. Although FIG. 2 displays that GPU 200 includes processing units 220-238, GPU 200 may include a number of additional processing units. Additionally, processing units 220-238 are merely an example and any combination or order of processing units may be used by GPUs according to the present disclosure. GPU 200 also includes command buffer 250, context register packets 260, and context states 261.

As shown in FIG. 2, a GPU may utilize a CP, e.g., CP 210, or hardware accelerator to parse a command buffer into context register packets, e.g., context register packets 260, and/or draw call data packets, e.g., draw call packets 212. The CP 210 may then send the context register packets 260 or draw call packets 212 through separate paths to the processing units or blocks in the GPU. Further, the command buffer 250 may alternate different states of context registers and draw calls. For example, a command buffer may be structured in the following manner: context register of context N, draw call(s) of context N, context register of context N+1, and draw call(s) of context N+1.

GPUs may render images in a variety of different ways. In some instances, GPUs may render an image using rendering and/or tiled rendering. In tiled rendering GPUs, an image may be divided or separated into different sections or tiles. After the division of the image, each section or tile may be rendered separately. Tiled rendering GPUs may divide computer graphics images into a grid format, such that each portion of the grid, i.e., a tile, is separately rendered. In some aspects, during a binning pass, an image may be divided into different bins or tiles. In some aspects, during the binning pass, a visibility stream may be constructed where visible primitives or draw calls may be identified. In contrast to tiled rendering, direct rendering does not divide the frame into smaller bins or tiles. Rather, in direct rendering, the entire frame is rendered at a single time. Additionally, some types of GPUs may allow for both tiled rendering and direct rendering.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in doubled data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Some types of GPUs may include different types of pipelines, such as a graphics processing pipeline. Graphics processing pipelines may include one or more of a vertex shader stage, a hull shader stage, a domain shader stage, a geometry shader stage, and a pixel shader stage. These stages of the graphics processing pipeline may be considered shader stages. These shader stages may be implemented as one or more shader programs that execute on shader units at a GPU. Shader units may be configured as a programmable pipeline of processing components. In some examples, a shader unit may be referred to as “shader processors” or “unified shaders,” and may perform geometry, vertex, pixel, or other shading operations to render graphics. Shader units may include shader processors, each of which may include one or more components for fetching and decoding operations, one or more arithmetic logic units (ALUs) for carrying out arithmetic calculations, one or more memories, caches, and registers.

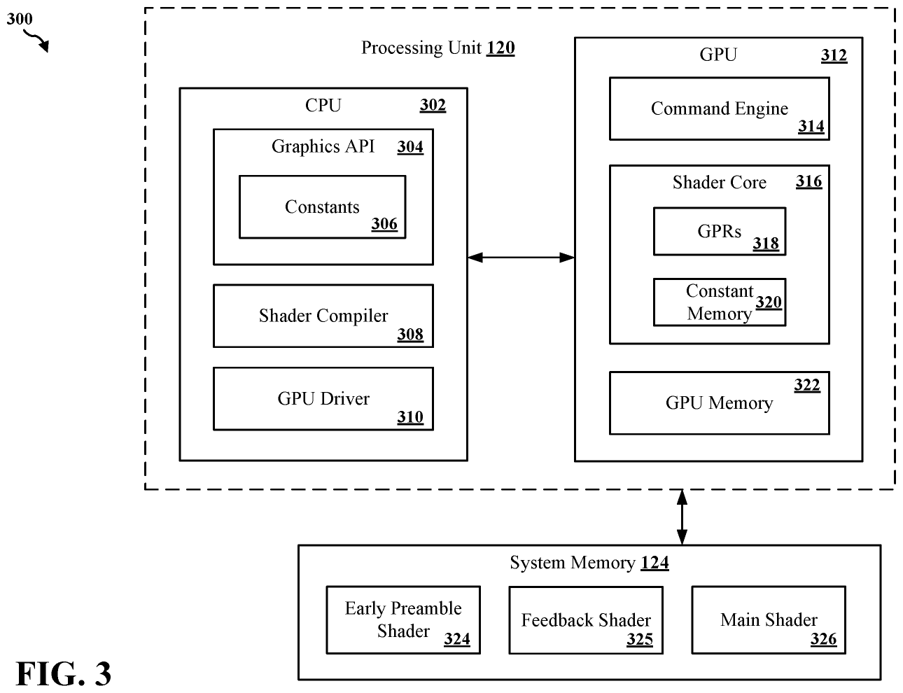

FIG. 3 is a diagram 300 that illustrates processing components, such as the processing unit 120 and the system memory 124, as may be identified in connection with the device 104 for processing data. In aspects, the processing unit 120 may include a CPU 302 and a GPU 312. The GPU 312 and the CPU 302 may be formed as an integrated circuit (e.g., a system-on-a-chip (SOC)) and/or the GPU 312 may be incorporated onto a motherboard with the CPU 302. Alternatively, the CPU 302 and the GPU 312 may be configured as distinct processing units that are communicatively coupled to each other. For example, the GPU 312 may be incorporated on a graphics card that is installed in a port of the motherboard that includes the CPU 302.

The CPU 302 may be configured to execute a software application that causes graphical content to be displayed (e.g., on the display(s) 131 of the device 104) based on one or more operations of the GPU 312. The software application may issue instructions to a graphics application program interface (API) 304, which may be a runtime program that translates instructions received from the software application into a format that is readable by a GPU driver 310. After receiving instructions from the software application via the graphics API 304, the GPU driver 310 may control an operation of the GPU 312 based on the instructions. For example, the GPU driver 310 may generate one or more command streams that are placed into the system memory 124, where the GPU 312 is instructed to execute the command streams (e.g., via one or more system calls). A command engine 314 included in the GPU 312 is configured to retrieve the one or more commands stored in the command streams. The command engine 314 may provide commands from the command stream for execution by the GPU 312. The command engine 314 may be hardware of the GPU 312, software/firmware executing on the GPU 312, or a combination thereof. While the GPU driver 310 is configured to implement the graphics API 304, the GPU driver 310 is not limited to being configured in accordance with any particular API. The system memory 124 may store the code for the GPU driver 310, which the CPU 302 may retrieve for execution. In examples, the GPU driver 310 may be configured to allow communication between the CPU 302 and the GPU 312, such as when the CPU 302 offloads graphics or non-graphics processing tasks to the GPU 312 via the GPU driver 310.

The system memory 124 may further store source code for one or more of an early preamble shader 324, a feedback shader 325, or a main shader 326. In such configurations, a shader compiler 308 executing on the CPU 302 may compile the source code of the shaders 324-326 to create object code or intermediate code executable by a shader core 316 of the GPU 312 during runtime (e.g., at the time when the shaders 324-326 are to be executed on the shader core 316). In some examples, the shader compiler 308 may pre-compile the shaders 324-326 and store the object code or intermediate code of the shader programs in the system memory 124. The shader compiler 308 (or in another example the GPU driver 310) executing on the CPU 302 may build a shader program with multiple components including the early preamble shader 324, the feedback shader 325, and the main shader 326. The main shader 326 may correspond to a portion or the entirety of the shader program that does not include the early preamble shader 324 or the feedback shader 325. The shader compiler 308 may receive instructions to compile the shader(s) 324-326 from a program executing on the CPU 302. The shader compiler 308 may also identify constant load instructions and common operations in the shader program for including the common operations within the early preamble shader 324 (rather than the main shader 326). The shader compiler 308 may identify such common instructions, for example, based on (presently undetermined) constants 306 to be included in the common instructions. The constants 306 may be defined within the graphics API 304 to be constant across an entire draw call. The shader compiler 308 may utilize instructions such as a preamble shader start to indicate a beginning of the early preamble shader 324 and a preamble shader end to indicate an end of the early preamble shader 324. Similar instructions may be used for the feedback shader 325 and the main shader 326. The feedback shader 325 will be described in further detail below.

The shader core 316 included in the GPU 312 may include general purpose registers (GPRs) 318 and constant memory 320. The GPRs 318 may correspond to a single GPR, a GPR file, and/or a GPR bank. Each GPR in the GPRs 318 may store data accessible to a single thread. The software and/or firmware executing on GPU 312 may be a shader program 324-326, which may execute on the shader core 316 of GPU 312. The shader core 316 may be configured to execute many instances of the same instructions of the same shader program in parallel. For example, the shader core 316 may execute the main shader 326 for each pixel that defines a given shape. The shader core 316 may transmit and receive data from applications executing on the CPU 302. In examples, constants 306 used for execution of the shaders 324-326 may be stored in a constant memory 320 (e.g., a read/write constant RAM) or the GPRs 318. The shader core 316 may load the constants 306 into the constant memory 320. In further examples, execution of the early preamble shader 324 or the feedback shader 325 may cause a constant value or a set of constant values to be stored in on-chip memory such as the constant memory 320 (e.g., constant RAM), the GPU memory 322, or the system memory 124. The constant memory 320 may include memory accessible by all aspects of the shader core 316 rather than just a particular portion reserved for a particular thread such as values held in the GPRs 318.

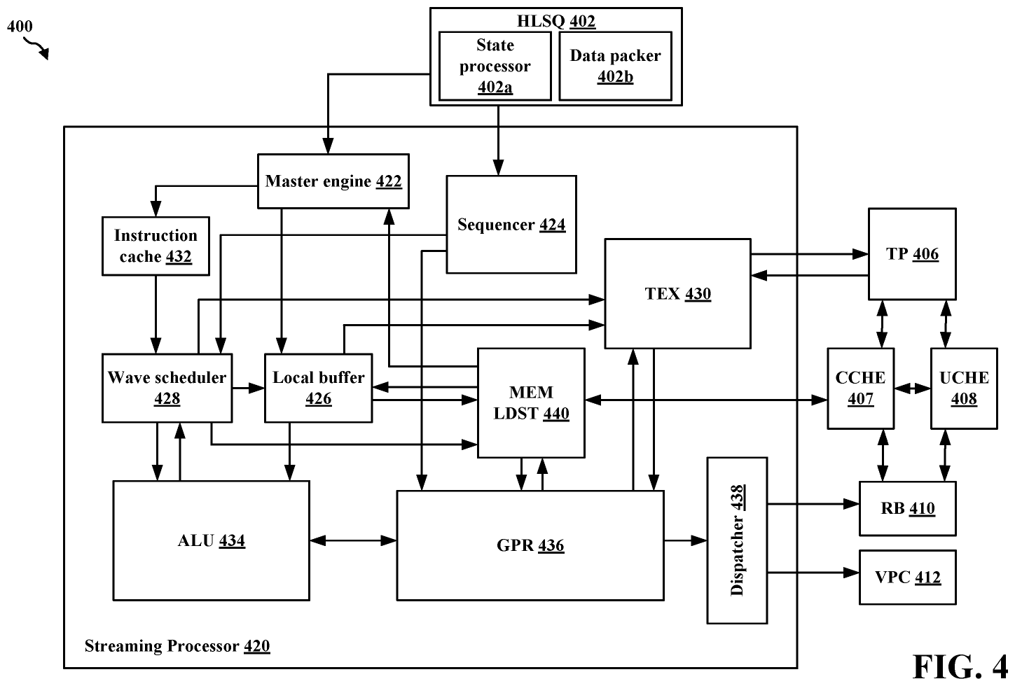

FIG. 4 illustrates an example GPU 400. Specifically, FIG. 4 illustrates a streaming processor (SP) system in GPU 400. As shown in FIG. 4, GPU 400 includes a high level sequencer (HLSQ) 402, texture processor (TP) 406, level 1 (L1) cache (cluster cache (CCHE)) 407, level 2 (L2) cache (UCHE) 408, render backend (RB) 410, and vertex cache (VPC) 412. GPU 400 also includes SP 420, master engine 422, sequencer 424, local buffer 426, wave scheduler 428, texture (TEX) 430, instruction cache 432, arithmetic logic unit (ALU) 434, GPR 436, dispatcher 438, and memory (MEM) load store (LDST) 440.

As shown in FIG. 4, each unit or block in GPU 400 may send data or information to other blocks. For instance, HLSQ 402 may send commands to the master engine 422. Also, HLSQ 402 may send vertex threads, vertex attributes, pixel threads, pixel attributes, and/or compute commands to the sequencer 424. TP 406 may receive texture requests from TEX 430, and send texture elements (texels) back to the TEX 430. Further, TP 406 may send memory read requests to and receive memory data from CCHE 407 or UCHE 408. CCHE 407 or UCHE 408 may also receive memory read or write requests from MEM LDST 440 and send memory data back to MEM LDST 440, as well as receive memory read or write requests from RB 410 and send memory data back to RB 410. Also, RB 410 may receive an output in the form of color from GPR 436, e.g., via dispatcher 438. VPC 412 may also receive output in the form of vertices from GPR 436, e.g., via dispatcher 438. GPR 436 may send address data or receive write back data from MEM LDST 440. GPR 436 may also send temporary data to and receive temporary data from ALU 434. Moreover, ALU 434 may send address or predicate information to the wave scheduler 428, as well as receive instructions from wave scheduler 428. Local buffer 426 may send constant data to ALU 434. TEX 430 may also receive texture attributes from or send texture data to GPR 436, as well as receive constant data from local buffer 426. Further, TEX 430 may receive texture requests from wave scheduler 428, as well as receive constant data from local buffer 426. MEM LDST 440 may send/receive constant data to/from local buffer 426. Sequencer 424 may send wave data to wave scheduler 428, as well as send data to GPR 436. The sequencer 424 may allocate resources and local memory. Also, the sequencer 424 may allocate wave slots and any associated GPR 436 space. For example, the sequencer 424 may allocate wave slots or GPR 436 space when the HLSQ 402 issues a pixel tile workload to the SP 420. Master engine 422 may send program data to instruction cache 432, as well as send constant data to local buffer 426 and receive instructions from MEM LDST 440. Instruction cache 432 may send instructions or decode information to wave scheduler 428. Wave scheduler 428 may send read requests to local buffer 426, as well as send memory requests to MEM LDST 440.

As further shown in FIG. 4, the HLSQ 402 may prepare one or more context states for the SP 420. For example, the HLSQ 402 may prepare the context states for different types of data, e.g., global register data, shader constant data, buffer descriptors, instructions, etc. Additionally, the HLSQ 402 may embed context states into a command stream to the SP 420. The master engine 422 may parse the command stream from the HLSQ 402 and setup an SP global state. Moreover, the master engine 422 may fill or add to an instruction cache 432 and/or a local buffer 426 or a constant buffer. In some aspects, inside the HLSQ 402, there may be an internal function unit called a state processor 402a. The state processor 402a may be a single fiber scalar processor that may execute a special shader program, e.g., a preamble shader. The preamble shader may be generated by the GPU compiler in order to load constant data from different buffer objects. Also, the preamble shader may bind the buffer objects into a single constant buffer, such as a post-process constant buffer. Further, the HLSQ 402 may execute the preamble shader and, as a result, skip utilizing a main shader. In some instances, the main shader may perform different shading tasks, such as normal vertex shading and/or a fragment shading program. Moreover, the HLSQ 402 may include a data packer 402b.

Additionally, as shown in FIG. 4, the SP 420 may not be limited to executing a preamble if the HLSQ 402 decides to skip a preamble execution. For instance, the SP 420 may also process a conventional graphics workload, such as vertex shading and/or fragment shading. In some aspects, the SP 420 may utilize its execution units and storage in order to process compute tasks as a general purpose GPU (GPGPU). Inside the SP 420, there may be multiple parallel instruction execution units such as an ALU, elementary function unit (EFU), branching unit, TEX, general memory read and write (aka LDST), etc. The SP 420 may also include on-chip storage memory, such as a GPR 436 which may store per-fiber private data. Also, the SP 420 may include a local buffer 426 which stores per-shader or per-kernel constant data, per-wave uniform data (aka uGPR), and per-compute work group (WG) local memory (LM). Processing a preamble shader may take up one wave slot. Further, the majority of preamble shaders may use just the uGPR and not the GPR, and may execute ALU instructions on a scalar ALU. Therefore, execution of the preamble shader may be associated with high performance, and may be power efficient because any available wave slot may be used to execute the preamble shader even without GPR space allocation.

Moreover, as shown in FIG. 4, dispatcher 438 may fetch data from GPR 436. Dispatcher 438 may also perform format conversion, and then dispatch a final color to multiple render targets (RTs). Each RT may have one or more components, such as red (r) green (G) blue (B) alpha (A) (RGBA) data, or just an alpha component of the RGBA data. Further, each RT may be generally stored in a vector GPR, i.e., R3.0 may store red data, R3.1 may store green data, R3.2 may store blue data, etc. Also, a driver program in an SP context register may be utilized to define the GPR identifier (ID) which stores RT data.

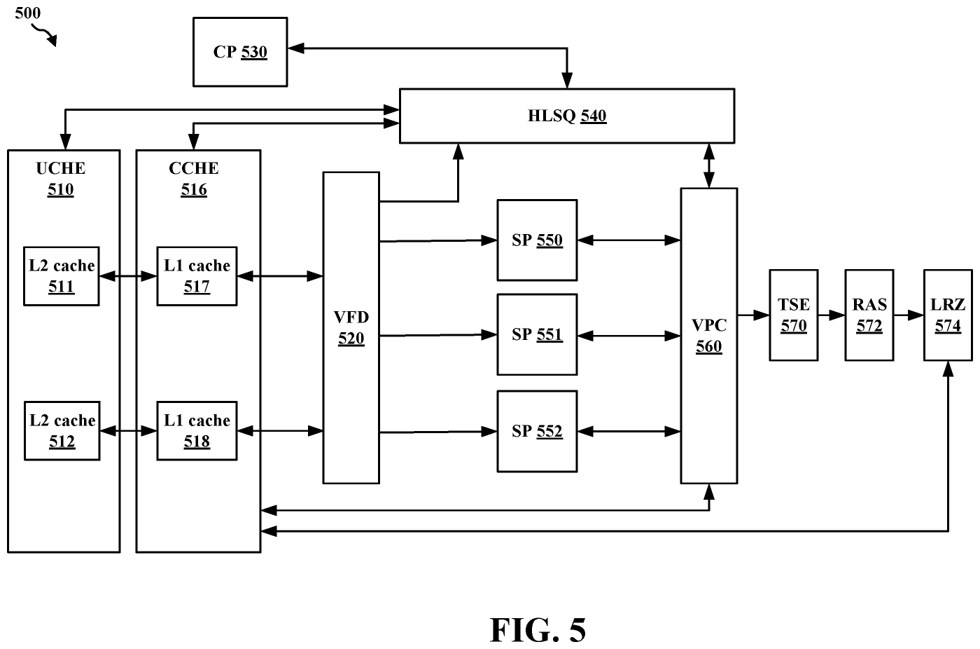

FIG. 5 is a diagram illustrating another example GPU. More specifically, FIG. 5 depicts GPU 500 including a number of different components. As shown in FIG. 5, GPU 500 includes UCHE 510 including L2 cache 511 and L2 cache 512, CCHE 516 including L1 cache 517 and L1 cache 518, VFD 520, CP 530, HLSQ 540, a number of SPs (e.g., SP 550, SP 551, and SP 552), VPC 560, TSE 570, RAS 572, and low resolution Z (LRZ) component (e.g., LRZ 574). As shown in FIG. 5, CP 530 may transmit data to HLSQ 540 and receive data from HLSQ 540. CCHE 516 may transmit/receive data to/from HLSQ 540. UCHE 510 may also transmit/receive data to/from HLSQ 540. L2 cache 511 and L2 cache 512 may transmit/receive data to/from VFD 520. Further, VFD 520 may transmit data to HLSQ 540, as well as transmit data to SPs 550-552. Moreover, SPs 550-552 may transmit/receive data to/from VPC 560. Also, VPC 560 may transmit/receive data to/from HLSQ 540. Data can also be transmitted from VPC 560 to TSE 570, which can transmit data to RAS 572, and then to LRZ 574. CCHE 516 can transmit/receive data to/from VPC 560 and LRZ 574. Also, UCHE 510 can transmit/receive data to/from VPC 560 and LRZ 574.

As depicted in FIG. 5, GPUs (e.g., GPU 500) may include a number of different caches. GPUs utilize caches for a variety of reasons, such as to transfer data at a sufficiently high rate of speed. That is, as processing power for GPUs has increased at a higher rate than memory access speed, storage resources (e.g., caches) between the processor and memory have been utilized to transfer data at a sufficient rate. Caches at GPUs are also utilized to more seamlessly transfer data. One benefit of caches is that they provide buffering, so caches and buffers may be similar. For instance, caches may decrease latency by reading data from memory in larger chunks based on subsequent data accessing nearby address locations. Also, caches may increase throughput by assembling multiple small transfers into larger, more efficient memory requests. These benefits may be achieved by a cache storing data in blocks called cache lines. A cache line may be a portion of data that can be mapped into a cache. For example, a cache line may be a smallest portion of data that can be mapped into a cache.

A Fourier transform (FT) is an integral transform that converts a function into a form that describes frequencies (e.g., frequencies present in an original function). The output of a Fourier transform is a complex-valued function of frequency. The term Fourier transform refers to both the complex-valued function and a mathematical operation. The Fourier transform is sometimes referred to as the frequency domain representation of the original function. A fast Fourier transform (FFT) is an algorithm that computes the discrete Fourier transform (DFT) of a sequence (i.e., a DFT may convert a finite sequence of equally-spaced samples of a function into a same-length sequence of equally-spaced samples of the discrete-time Fourier transform (DTFT), which is a complex-valued function of frequency), or an inverse discrete Fourier transform (IDFT). A Fourier analysis may convert a signal from its original domain (e.g., time or space) to a representation in the frequency domain (and vice versa). In some aspects, a DFT may be obtained by decomposing a sequence of values into components of different frequencies

A fast Fourier Transform (FFT) may decompose a waveform into its underlying frequencies, such as in a computationally efficient way. FFTs are widely used across a variety of signal processing applications. For example, FFTs may be used in image processing, filtering, object recognition, cryptography, robotics, manufacturing, and cellular communication. In some respects, an FFT may be computed for use in different types of processing. In one example, an FFT may be computed using a graphics processing unit (GPU) for a radar processing pipeline.

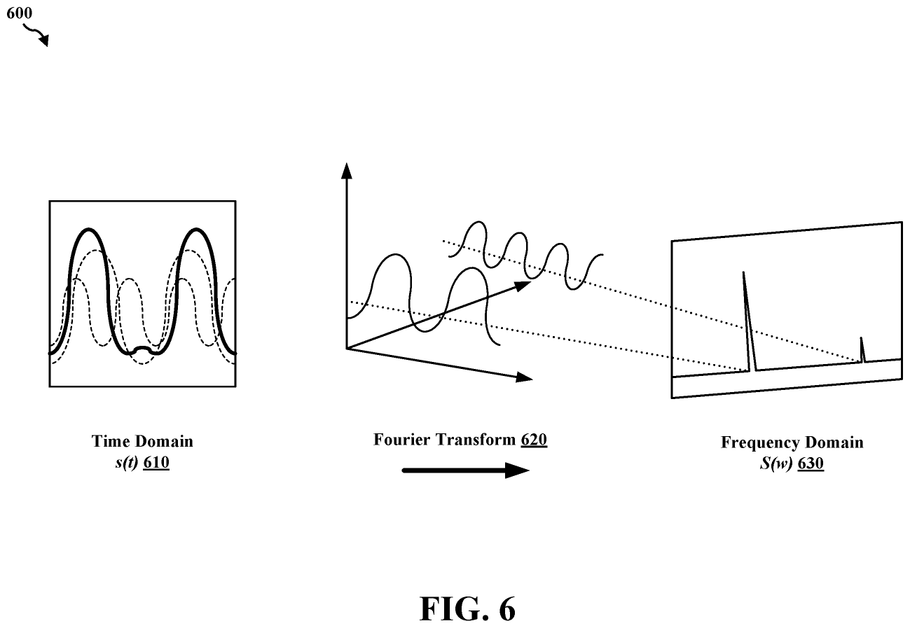

FIG. 6 illustrates diagram 600 including one example of a Fourier transform. More specifically, diagram 600 depicts a Fourier transform of signals in a time domain to a frequency domain. As shown in FIG. 6, diagram 600 includes a time domain signal s(t) 610, a Fourier transform 620, and a frequency domain signal S(w) 630. FIG. 6 shows one example of a signal (e.g., time domain signal s(t) 610) being Fourier transformed (e.g., via Fourier transform 620) from a time domain to a frequency domain, which results in a frequency domain signal (e.g., frequency domain signal S(w) 630). That is, FIG. 6 depicts that time domain signal s(t) 610 undergoes a Fourier transform 620 to result in frequency domain signal S(w) 630.

In some aspects of graphics processing, it may be beneficial to optimize the fast Fourier transform (FFT) for certain components (e.g., a GPU). For example, some components (e.g., a digital signal processor (DSP)) may not be available to compute an FFT, so it may be beneficial to offload the FFT calculations to other components (e.g., a graphics processing unit (GPU)). Indeed, many FFT applications may specify real-time execution speed, so it may be desirable to offload certain calculations (e.g., calculations associated with a radar processing pipeline) from one component (e.g., a DSP) to another component (e.g., a GPU). By doing so, this may free up the component (e.g., a DSP) for other calculations and/or tasks. For a given task (e.g., a radar pipeline), one bottleneck of calculations may be computing a one-dimensional FFT (e.g., 65536 rows of 32-point FFT in parallel). For instance, a high performance FFT may be achieved with specialized kernels optimized for GPU (e.g., open computing language (OpenCL) kernels).

In some instances, there may be many variations of implementing an FFT on a GPU. One popular type of implementation is the Cooley-Tukey algorithm. A typical implementation of the Cooley-Tukey algorithm on GPU uses multiple fibers and stores intermediate results in local memory. The Cooley-Tukey algorithm re-expresses the discrete Fourier transform (DFT) of an arbitrary composite size in terms of smaller DFTs of sizes, recursively, to reduce the computation time for certain sizes (e.g., smooth numbers). Because the Cooley-Tukey algorithm breaks a DFT into smaller DFTs, it may be combined arbitrarily with any other algorithm for the DFT. Additionally, the Cooley-Tukey FFT may load data in a bit-reversed order, meaning that a vectorized load cannot be used. While this approach is flexible and works for certain FFT sizes (e.g., all power of 2 FFT sizes), it is may not be optimized specifically for the 32-point FFT. Another common FFT approach is the Stockham FFT, which also works for certain powers (e.g., all powers of 2), and similarly uses multiple fibers and stores intermediate results in local memory. However, the Stockham FFT does not use a bit-reverse step, and instead reshuffles data between each butterfly iteration. The Cooley-Tukey and Stockham FFTs are most commonly a radix-2 formulation, but can also be implemented at different radix formulations.

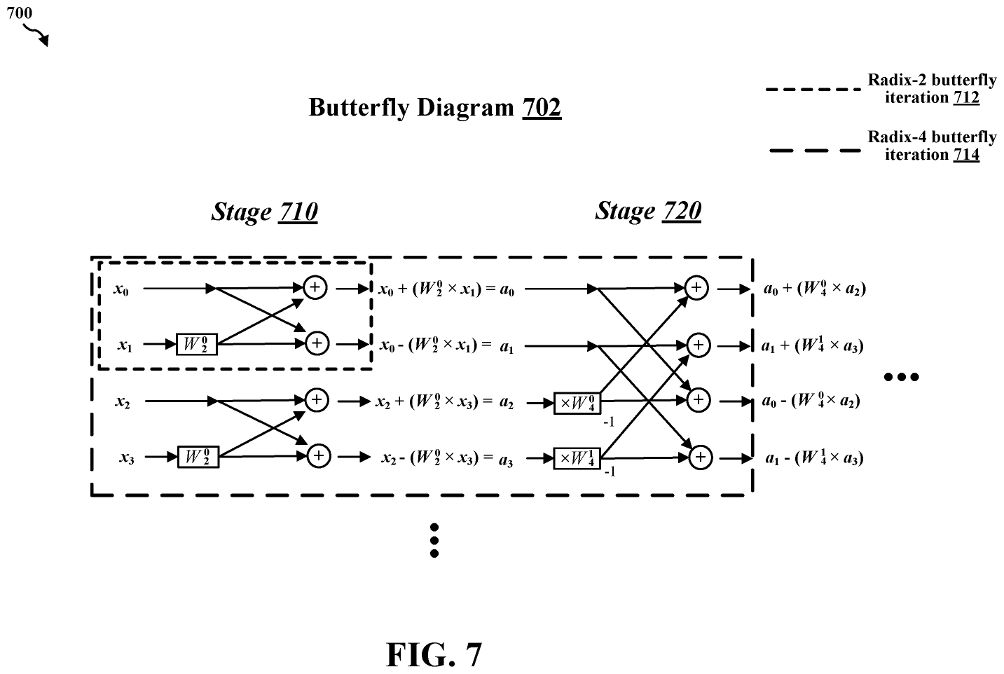

FIG. 7 illustrates diagram 700 including one example of a butterfly diagram. More specifically, diagram 700 depicts a diagram of the butterfly computation for a Cooley-Tukey algorithm. The bit-reverse step is not depicted in FIG. 7, as the input data is presumed to already be in bit-reversed order. As shown in FIG. 7, diagram 700 includes butterfly diagram 702 including stage 710 and stage 720, as well as different butterfly iterations (e.g., Radix-2 butterfly iteration 712 and Radix-4 butterfly iteration 714). FIG. 7 depicts that Radix-2 butterfly iteration 712 occurs entirely within stage 710, while Radix-4 butterfly iteration 714 occurs within stage 710 and stage 720. It may also be possible to make simplifications to the higher radix butterfly iterations to improve computational efficiency by reducing the number of non-trivial multiplications and additions.

As shown in FIG. 7, certain types of algorithms (e.g., Cooley-Tukey algorithms) may utilize butterfly iterations. In the context of FFT algorithms, a butterfly iteration is a portion of the computation that may combine the results of smaller discrete Fourier transforms (DFTs) into a larger DFT, or vice versa (e.g., breaking a larger DFT up into sub-transforms). The name “butterfly” refers to the shape of the data-flow diagram (e.g., the shape of the data-flow diagram in the Radix-2 butterfly iteration 712). As depicted in FIG. 7, the term “butterfly” appears in the context of the Cooley-Tukey FFT algorithm, which recursively breaks down a DFT of composite size (e.g., size n=r*m) into smaller transforms (e.g., r smaller transforms) of a certain size (e.g., size m), where r is the “radix” of the transform. These smaller DFTs may then be combined via differently size butterflies (e.g., size-r butterflies), which themselves are DFTs of size r (performed m times on corresponding outputs of the sub-transforms) pre-multiplied by roots of unity (known as twiddle factors). In some instance, the butterfly iterations may be post-multiplied by twiddle factors. A twiddle factor, in FFT algorithms, may be any of the trigonometric constant coefficients that are multiplied by the data in the course of the algorithm. In the case of the Radix-2 butterfly iteration 712 shown in FIG. 7, the butterfly is a DFT of size-2 that takes two inputs (x0, x1) (corresponding outputs of the two sub-transforms) and gives two outputs (y0, y1). A radix is a base of a system of numeration.

Based on the above, it may be beneficial to offload FFT calculations from certain components (e.g., DSPs) to other components (e.g., a GPUs). For instance, some FFT applications may specify real-time execution speed, so it may be desirable to offload certain calculations (e.g., calculations associated with a radar processing pipeline) from one component (e.g., a DSP) to another component (e.g., a GPU). By doing so, this may free up certain components (e.g., a DSP) for other calculations and/or tasks. Additionally, it may be beneficial to optimize FFT algorithms for GPUs. It may also be beneficial to utilize an optimal FFT implementation dependent on specific GPU hardware. Further, it may be beneficial to utilize a higher order of radix butterfly iteration for computing FFT calculations.

Aspects of the present disclosure may perform FFT calculations at certain components (e.g., GPUs), such as to offload FFT calculations from other components (e.g., DSPs). For instance, aspects of the present disclosure may free up certain components (e.g., DSPs) for other calculations and/or tasks by performing FFT calculations at certain components (e.g., GPUs). That is, aspects presented herein may optimize FFT algorithms for certain components (e.g., GPUs). Moreover, aspects presented herein may utilize an optimal FFT implementation that is hardware dependent at certain components (e.g., GPUs). Also, aspects presented herein may utilize a higher order of radix butterfly iteration for computing FFT calculations. Additionally, aspects presented herein may utilize consecutive butterfly iterations which may be merged for higher radix calculations.

Aspects presented herein may relate to a feasibility of offloading a radar processing pipeline from one component (e.g., a DSP) to another component (e.g., a GPU) in order to free up one component (e.g., a DSP) for other tasks. In some instances, the main bottleneck of a calculation pipeline (e.g., a radar pipeline) may be computing a number of rows (e.g., 65536 rows) of a one-dimensional FFT (e.g., a 32-point FFT) in parallel. There are many variations of implementing FFT on certain components (e.g., GPUs) including the Cooley-Tukey and Stockham FFTs, as discussed above. For example, aspects presented herein may utilize a higher radix FFT (e.g., a higher radix 32-point FFT) for computing FFT operations (e.g., a 32×65536 FFT). The 32-point FFT is a single kernel using just one fiber to compute each 32-point FFT, which may mean that the load and store can be completely vectorized. In additional, no local memory may need to be used (e.g., at a GPU) and all data may be stored in registers. The same approach may also be implemented for other FFTs (e.g., a 4-point FFT, an 8-point FFT, and/or a 16-point FFT) as a corresponding radix (e.g., radix-4, radix-8, radix-16, etc.). This may also work with certain types of floating point calculations (e.g., FP32, FP16). Also, certain radix kernels (e.g., radix-4, radix-8, radix-16, and radix-32 kernels) may achieve excellent performance and bandwidth utilization close to the theoretical maximum.

Aspects presented herein may utilize a higher radix FFT implementation. Higher radix implementations utilized herein may be specifically optimized for certain types of FFTs (e.g., 4-point FFTs, 8-point FFTs, 16-point FFTs, and 32-point FFTs). As utilized herein, “higher radix” or “high radix” may refer to a type of radix that is higher than another type of radix. For example, radix-4, radix-8, radix-16, or radix-32 may be higher than radix-2, so “higher radix” or “high radix” may refer to these types of radix operations. In aspects presented herein, a radix kernel (e.g., a radix-4, radix-8, radix-16, or radix-32 kernel) may compute an FFT (e.g., a one-dimensional FFT) using just registers and a load/store process (e.g., a fully vectorized load/store process). That is, aspects presented herein may utilize a single kernel call and a load/store process (e.g., a fully vectorized load/store process). In contrast, some solutions, such as a Cooley-Tukey FFT or a mixed-radix FFT, may use multiple kernel calls or local/GMEM/global memory at a GPU. Accordingly, higher radix FFT implementations utilized herein may perform FFT calculations at a faster pace and utilize a reduced amount of memory.

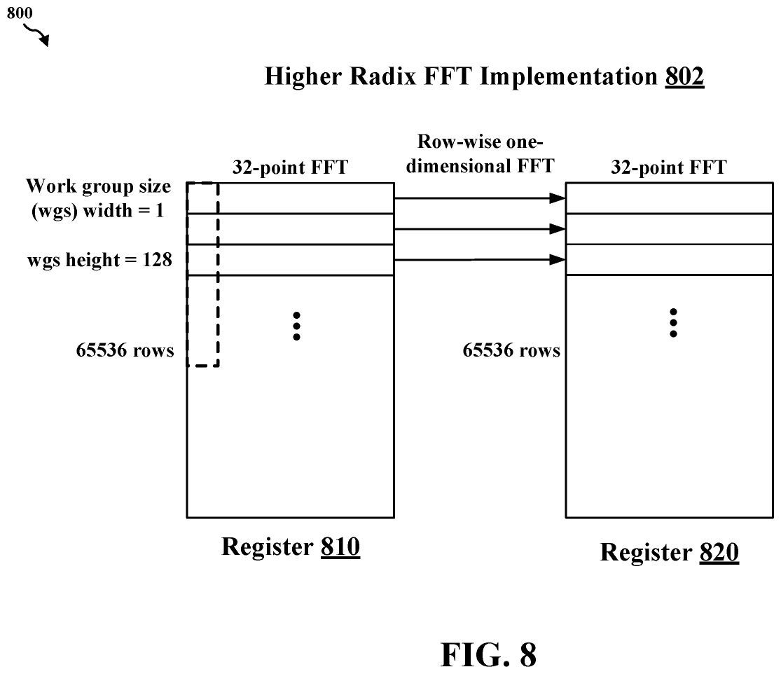

FIG. 8 illustrates diagram 800 including one example of an FFT implementation. More specifically, diagram 800 depicts a higher radix FFT implementation according to aspects presented herein. As shown in FIG. 8, diagram 800 includes higher radix FFT implementation 802 including register 810 and register 820. The FFT computation can be performed in-place, so register 810 and register 820 may be the same physical location in memory. FIG. 8 depicts a higher radix FFT implementation 802 that is specifically optimized for certain types of FFTs (e.g., 4-point, 8-point, 16-point, and 32-point FFTs). That is, diagram 800 depicts a computation of a one-dimensional FFT, where a time domain signal is decomposed to frequency components that correspond to a single row in a one-dimensional FFT (e.g., a row-wise one-dimensional FFT). As shown in FIG. 8, each of the 65,536 rows is an independent FFT computation of a 32-point FFT. So the time domain signal may include 32 points. In order to optimize the FFT calculation, aspects presented herein may solely utilize registers in a fully-vectorized load store process (e.g., at a GPU). So the dotted box is the work group size (wgs) in the OpenCL kernel, and each row is being computed by a single fiber. That is, each fiber can fully utilize the bandwidth of loading and storing the data, all the data is solely used in registers, and so aspects presented herein may avoid any sort of synchronization in the higher radix FFT implementation. For example, aspects presented herein may avoid additional kernel calls or intermediate storing of results in memory (e.g., at local memory, graphics memory, or global memory). FIG. 8 illustrates a one-dimensional usage of the higher radix FFT, but the higher radix FFT can also be used in higher dimensional problems (e.g., two-dimensional FFT).

Aspects presented herein may also utilize butterfly iterations for higher radix FFT implementations. For instance, aspects presented herein may utilize consecutive butterfly iterations that can be merged for higher radix FFT implementations. That is aspects, presented herein may merge butterfly iterations into consecutively larger stages of FFT. For example, aspects presented herein may merge butterfly iterations from one butterfly iteration (e.g., Radix-2 butterfly iteration 712 in FIG. 7) into another butterfly iteration (e.g., Radix-4 butterfly iteration 714 in FIG. 7). This merging of butterfly iterations may occur for any number of radix butterfly iterations (e.g., butterfly iterations of Radix-2, Radix-4, Radix-8, Radix-16, Radix-32, Radix-64, etc.). Indeed, aspects presented herein may increase the amount of work per fiber by merging together all of the computations.

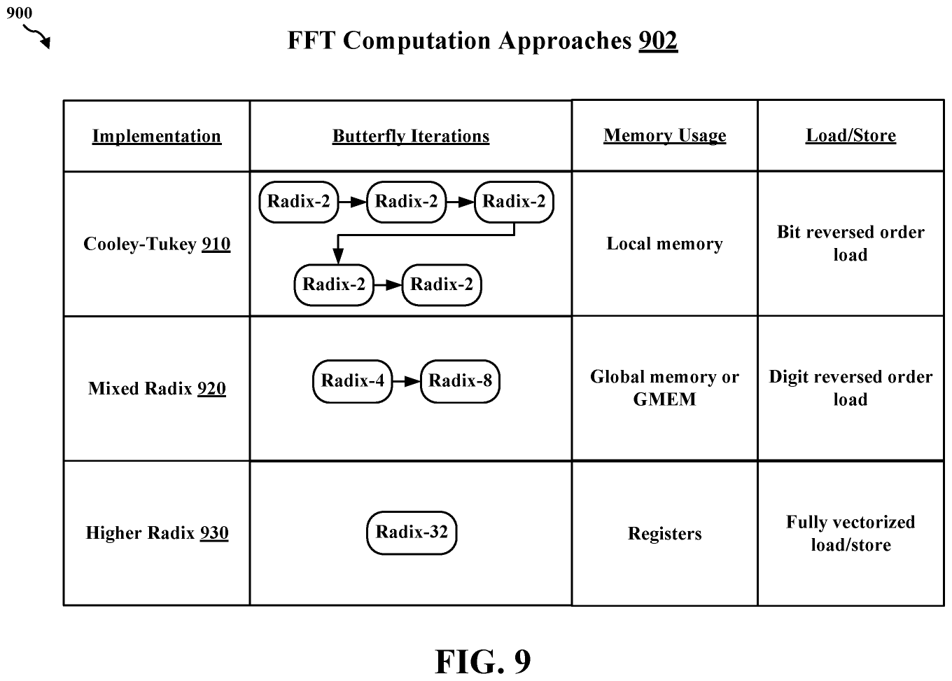

FIG. 9 illustrates diagram 900 including examples of FFT computation approaches. More specifically, diagram 900 depicts different types of FFT computation approaches. As shown in FIG. 9, diagram 900 shows FFT computation approaches 902 including Cooley-Tukey computation 910, mixed radix computation 920, and higher radix computation 930. As shown in FIG. 9, Cooley-Tukey computation 910 may utilize Radix-2 butterfly iterations, a local memory usage, and a bit-reversed order load. The downside of this approach is a slow performance that is limited by local memory, synchronization, and load pattern. A mixed radix computation 920 may utilize Radix-4 and Radix-8 butterfly iterations, a global memory or graphics memory (GMEM) usage, and a digit-reversed order load. The downside of this approach is it may be limited by memory access between kernels, synchronization, and load pattern. Also, a higher radix computation 930 may utilize a Radix-32 butterfly iteration, memory registers, and a fully-vectorized load/store.

The higher radix computation approach according to aspects of the present disclosure may provide the best performance. Further, the higher radix FFT may utilize a single stage Radix-32 stage using solely the registers for memory storage. Indeed, the fully vectorized load/store and avoiding synchronization may result in the best performance for the higher radix FFT. For example, a 32-point FFT may be the largest FFT that aspects presented herein may be able to compute on the GPU. The higher radix computation approach (e.g., for Radix-4, Radix-8, Radix-16, Radix-32, Radix-64, etc.) may execute the FFT computation faster than any other approach. For instance, the higher radix computation approach may execute the FFT computation on a GPU faster than any other FFT computation approach. Indeed, there may be alternative approaches to computing the FFT, but none compute the FFT as quickly as the higher radix computation (e.g., for 4-point, 8-point, 16-point, and 32-point FFTs).

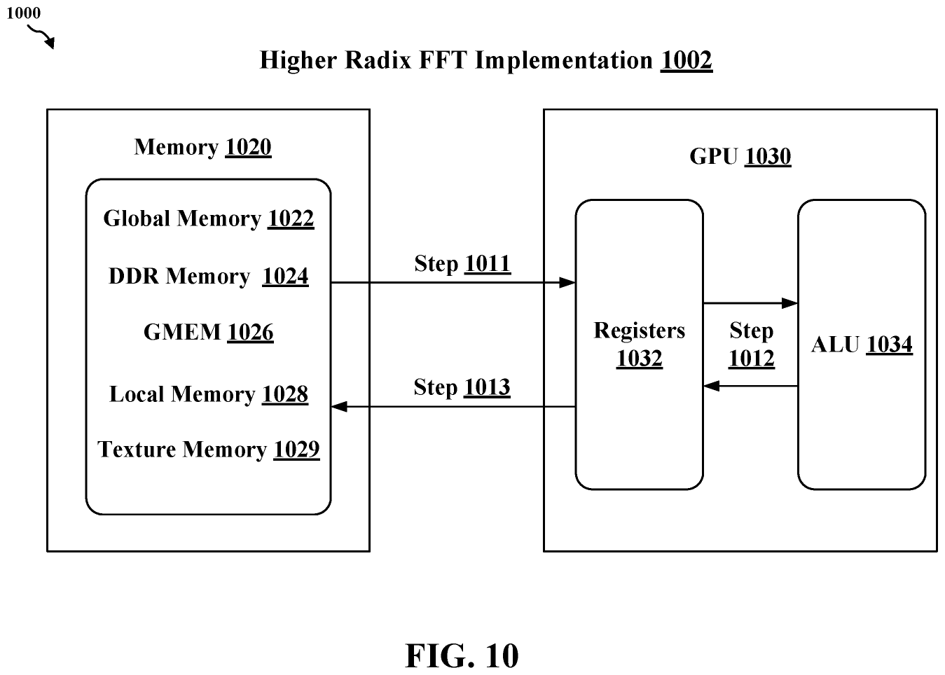

FIG. 10 illustrates diagram 1000 including one example of an FFT implementation. More specifically, diagram 1000 depicts a higher radix FFT implementation 1002. As shown in FIG. 10, diagram 1000 depicts higher radix FFT implementation 1002 including memory 1020 and GPU 1030. FIG. 10 depicts that memory 1020 may include global memory 1022, double data rate (DDR) memory 1024, graphics memory (GMEM) 1026, local memory 1028, and texture memory 1029. GPU 1030 may include registers 1032 and arithmetic logic unit (ALU) 1034. As shown in FIG. 10, at step 1011, an input signal may be loaded in a natural order (e.g., consecutive order) from memory 1020 to registers 1032 of designated processor units (e.g., GPU 1030). At step 1012, an FFT algorithm may be utilized to compute the discrete Fourier transform (DFT). The FFT algorithm may include of butterfly computation and scaling by twiddle factors. Also, the signal may be arranged in a natural order (e.g., consecutive order) in registers 1032. Step 1012 may also transfer information from/to the registers 1032 to/from the arithmetic logic unit (ALU) 1034. At step 1013, an output signal may be stored in a natural order (e.g., consecutive order) from registers 1032 to memory 1020 (e.g., global memory 1022, double data rate (DDR) memory 1024, graphics memory (GMEM) 1026, local memory 1028, or texture memory 1029).

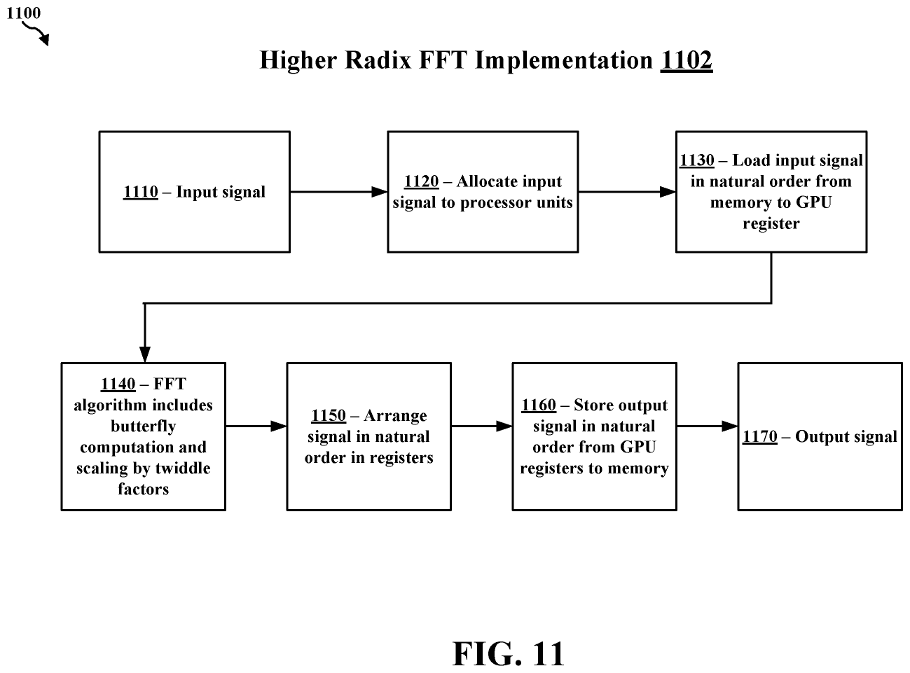

FIG. 11 illustrates diagram 1100 including one example of a higher radix FFT implementation. More specifically, diagram 1100 depicts a flowchart for higher radix FFT implementation 1102 at a GPU. As shown in FIG. 11, at 1110, the GPU may obtain an input signal (e.g., a data set that corresponds to the input signal). At 1120, the GPU may allocate the input signal (e.g., a data set that corresponds to the input signal) to different processor units (e.g., GPUs). At 1130, the GPU may load the input signal (e.g., a data set that corresponds to the input signal) in a natural order (e.g., consecutive order) from a memory to a GPU register. As shown in FIG. 11, at 1140, the FFT algorithm may include a butterfly computation and scaling by twiddle factors. At 1150, the GPU may arrange the input signal (e.g., a data set that corresponds to the input signal) in a natural order (e.g., consecutive order). At 1160, the GPU may store an output signal (e.g., a data set that corresponds to the output signal) in a natural order (e.g., consecutive order) from the GPU registers to memory (e.g., global memory, double data rate (DDR) memory, graphics memory (GMEM), local memory, and/or texture memory). At 1170, the GPU may output (e.g., transmit or store) the output signal (e.g., a data set that corresponds to the output signal).

Aspects of the present disclosure may include a number of benefits or advantages. For instance, aspects of the present disclosure may optimize FFT algorithms for certain components (e.g., GPUs). Moreover, aspects presented herein may utilize an optimal FFT implementation that is hardware dependent at certain components (e.g., GPUs). Also, aspects presented herein may utilize a higher order of radix butterfly iteration for computing FFT calculations. Additionally, aspects presented herein may utilize consecutive butterfly iterations which may be merged for higher radix calculations. Based on this, aspects of the present disclosure may execute FFT computations at an increased speed. That is, aspects presented herein may utilize a higher radix computation approach to execute the FFT computations on a GPU faster than any other FFT computation approach. Further, aspects presented herein may utilize a reduce amount of memory in order to execute the FFT computations. More precisely, aspects presented herein may utilize GPU registers to store FFT computations, rather than other memory.

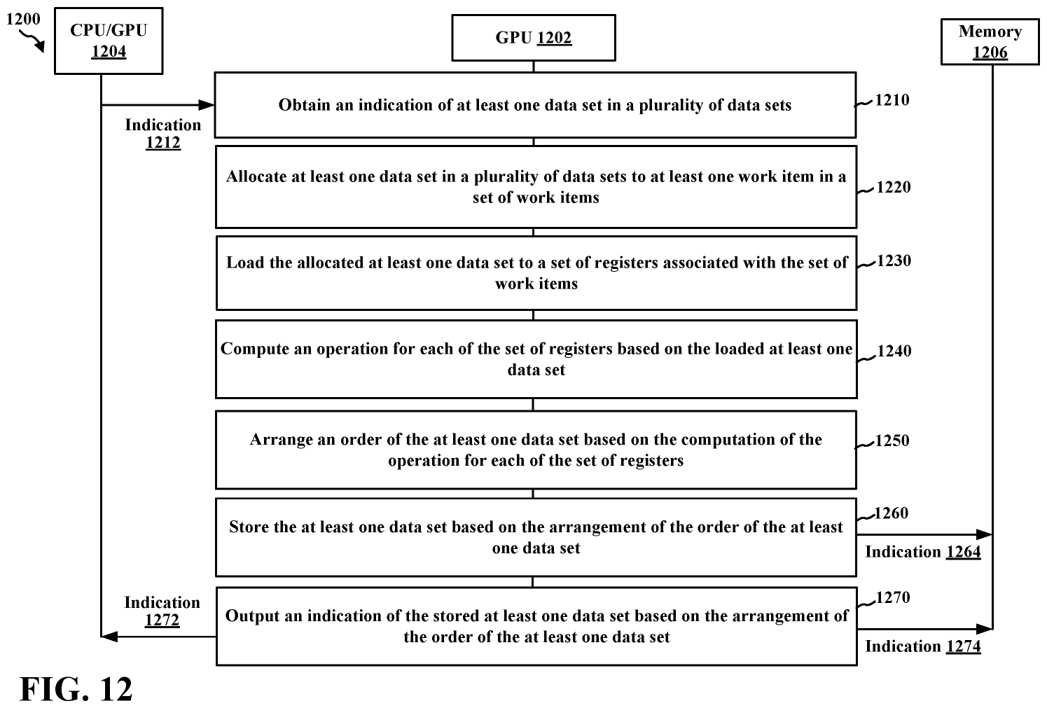

FIG. 12 is a communication flow diagram 1200 of graphics processing in accordance with one or more techniques of this disclosure. As shown in FIG. 12, diagram 1200 includes example communications between GPU 1202 (e.g., a GPU, a cache at a GPU, a GPU component, another graphics processor, a CPU, a CPU component, or another central processor), CPU/GPU 1204 (e.g., a GPU, a cache at a GPU, a GPU component, another graphics processor, a CPU, a CPU component, or another central processor), and memory 1206 (e.g., a memory, a cache, a system memory, a graphics memory, a memory or cache at a CPU, or a memory or cache at a GPU), in accordance with one or more techniques of this disclosure.

At 1210, GPU 1202 may obtain an indication of the at least one data set in the plurality of data sets (e.g., GPU 1202 may obtain indication 1212 from CPU/GPU 1204), where the allocation of the at least one data set may be based on the indication. In some aspects, obtaining the indication of the at least one data set may comprise: receiving at least one input signal associated with the at least one data set; or obtaining the indication of the at least one input signal associated with the at least one data set.

At 1220, GPU 1202 may allocate at least one data set in a plurality of data sets to at least one work item in a set of work items. In some aspects, allocating the at least one data set to the at least one work item may comprise: performing a one-to-one mapping of the at least one data set to the at least one work item. Also, allocating the at least one data set to the at least one work item may comprise: selecting the at least one data set for the at least one work item; or dividing the at least one data set amongst the at least one work item. In some aspects, the plurality of data sets may comprise at least one of: a plurality of signals, a plurality of source signals, a plurality of radio detection and rangings (radars), or a plurality of light detection and rangings (lidars). Also, at least one of the plurality of signals, the plurality of source signals, the plurality of radars, or the plurality of lidars may correspond to one of: a time domain, a spatial domain, or a frequency domain. Further, each data set of the plurality of data sets may be associated with a source of one of the plurality of signals, the plurality of source signals, the plurality of radars, or the plurality of lidars. Moreover, each data set of the plurality of data sets may be a continuous data stream for at least one of the plurality of signals, the plurality of source signals, the plurality of radars, or the plurality of lidars. In some aspects, the set of work items may be included in a compute unit located in a graphics processing unit (GPU); and each work item of the set of work items may correspond to a lane of a single-instruction multiple-data (SIMD) unit.

At 1230, GPU 1202 may load the allocated at least one data set to a set of registers associated with the set of work items. In some aspects, loading the allocated at least one data set to the set of registers may comprise loading the allocated at least one data set to the set of registers in a linear fashion or in a contiguous data set. For instance, this may maximize a bandwidth of a GPU (e.g., a 32-bit bandwidth, a 64-bit bandwidth, a 128-bit bandwidth, or a 256-bit bandwidth).

At 1240, GPU 1202 may compute an operation for each of the set of registers based on the loaded at least one data set. In some aspects, computing the operation for each of the set of registers may comprise: computing a fast Fourier Transform (FFT) operation using a sequence of iterations for each of the set of registers. The FFT operation may include one or more of: at least one butterfly computation, or a scaling operation associated with a set of twiddle factors. Also, the sequence of iterations may include one or more of: a sequence of butterfly iterations, or at least one radix iteration (e.g., a Radix-2 iteration, a Radix-4 iteration, a Radix-7 iteration, a Radix-8 iteration, a Radix-16 iteration, a Radix-32 iteration, or a Radix-64 iteration).

At 1250, GPU 1202 may arrange an order of the at least one data set based on the computation of the operation for each of the set of registers. In some aspects, arranging the order of the at least one data set may comprise: performing a bit reverse operation on the at least one data set if a length of the at least one data set is a power of two (2); or performing a bit manipulation on the at least one data set if a length of the at least one data set is not a power of two (2). Also, in some aspects, arranging the order of the at least one data set may comprise arranging the order of the at least one data set in the set of registers.

At 1260, GPU 1202 may store the at least one data set based on the arrangement of the order of the at least one data set (e.g., GPU 1202 may store indication 1264 in memory 1206). In some aspects, storing the at least one data set may comprise storing the at least one data set in a memory (e.g., memory at a GPU, external memory, local memory, system memory, graphics memory (GMEM), texture memory, a buffer).

At 1270, GPU 1202 may output an indication of the stored at least one data set based on the arrangement of the order of the at least one data set. In some aspects, outputting the indication of the stored at least one data set may comprise transmitting at least one output signal associated with the stored at least one data set (e.g., GPU 1202 may transmit indication 1272 to CPU/GPU 1204); or storing the indication of the at least one output signal associated with the stored at least one data set (e.g., GPU 1202 may store indication 1274 in memory 1206).

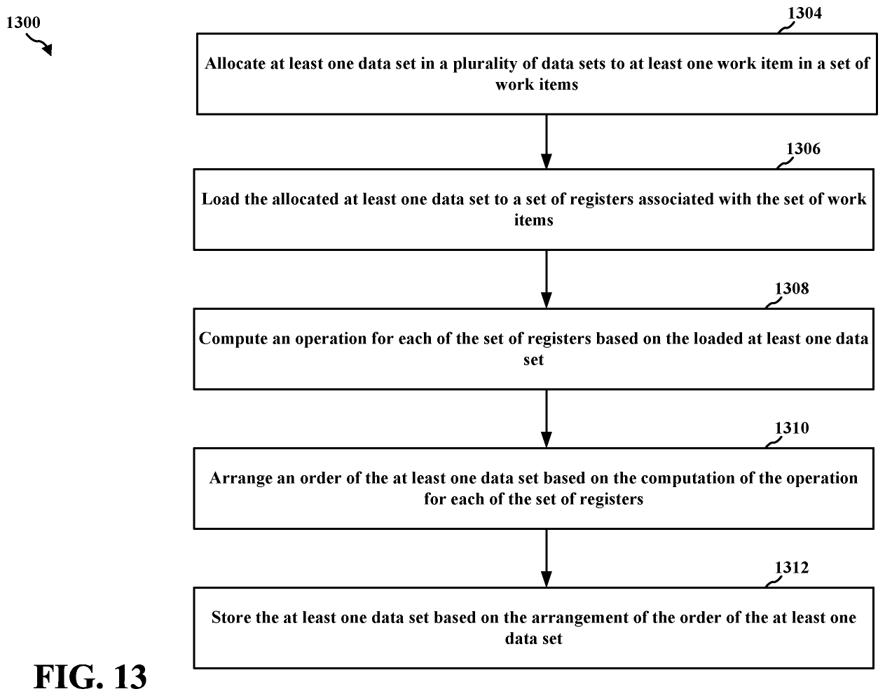

FIG. 13 is a flowchart 1300 of an example method of graphics processing in accordance with one or more techniques of this disclosure. The method may be performed by a GPU (e.g., a GPU, a cache at a GPU, a GPU component, another graphics processor, a CPU, a CPU component, or another central processor), a CPU (e.g., a CPU, a cache at a CPU, a CPU component, another central processor, a GPU, a GPU component, or another graphics processor), a display driver integrated circuit (DDIC), an apparatus for data or graphics processing, a wireless communication device, and/or any apparatus that may perform data or graphics processing as used in connection with the examples of FIGS. 1-12.

At 1304, the GPU may allocate at least one data set in a plurality of data sets to at least one work item in a set of work items, as described in connection with the examples in FIGS. 1-12. For example, as described in 1220 of FIG. 12, GPU 1202 may allocate at least one data set in a plurality of data sets to at least one work item in a set of work items. Further, step 1304 may be performed by processing unit 120 in FIG. 1. In some aspects, allocating the at least one data set to the at least one work item may comprise: performing a one-to-one mapping of the at least one data set to the at least one work item. Also, allocating the at least one data set to the at least one work item may comprise: selecting the at least one data set for the at least one work item; or dividing the at least one data set amongst the at least one work item. In some aspects, the plurality of data sets may comprise at least one of: a plurality of signals, a plurality of source signals, a plurality of radio detection and rangings (radars), or a plurality of light detection and rangings (lidars). Also, at least one of the plurality of signals, the plurality of source signals, the plurality of radars, or the plurality of lidars may correspond to one of: a time domain, a spatial domain, or a frequency domain. Further, each data set of the plurality of data sets may be associated with a source of one of the plurality of signals, the plurality of source signals, the plurality of radars, or the plurality of lidars. Moreover, each data set of the plurality of data sets may be a continuous data stream for at least one of the plurality of signals, the plurality of source signals, the plurality of radars, or the plurality of lidars. In some aspects, the set of work items may be included in a compute unit located in a graphics processing unit (GPU); and each work item of the set of work items may correspond to a lane of a single-instruction multiple-data (SIMD) unit.

At 1306, the GPU may load the allocated at least one data set to a set of registers associated with the set of work items, as described in connection with the examples in FIGS. 1-12. For example, as described in 1230 of FIG. 12, GPU 1202 may load the allocated at least one data set to a set of registers associated with the set of work items. Further, step 1306 may be performed by processing unit 120 in FIG. 1. In some aspects, loading the allocated at least one data set to the set of registers may comprise loading the allocated at least one data set to the set of registers in a linear fashion or in a contiguous data set. For instance, this may maximize a bandwidth of a GPU (e.g., a 32-bit bandwidth, a 64-bit bandwidth, a 128-bit bandwidth, or a 256-bit bandwidth).

At 1308, the GPU may compute an operation for each of the set of registers based on the loaded at least one data set, as described in connection with the examples in FIGS. 1-12. For example, as described in 1240 of FIG. 12, GPU 1202 may compute an operation for each of the set of registers based on the loaded at least one data set. Further, step 1308 may be performed by processing unit 120 in FIG. 1. In some aspects, computing the operation for each of the set of registers may comprise: computing a fast Fourier Transform (FFT) operation using a sequence of iterations for each of the set of registers. The FFT operation may include one or more of: at least one butterfly computation, or a scaling operation associated with a set of twiddle factors. Also, the sequence of iterations may include one or more of: a sequence of butterfly iterations, or at least one radix iteration (e.g., a Radix-2 iteration, a Radix-4 iteration, a Radix-7 iteration, a Radix-8 iteration, a Radix-16 iteration, a Radix-32 iteration, or a Radix-64 iteration).

At 1310, the GPU may arrange an order of the at least one data set based on the computation of the operation for each of the set of registers, as described in connection with the examples in FIGS. 1-12. For example, as described in 1250 of FIG. 12, GPU 1202 may arrange an order of the at least one data set based on the computation of the operation for each of the set of registers. Further, step 1310 may be performed by processing unit 120 in FIG. 1. In some aspects, arranging the order of the at least one data set may comprise: performing a bit reverse operation on the at least one data set if a length of the at least one data set is a power of two (2); or performing a bit manipulation on the at least one data set if a length of the at least one data set is not a power of two (2). Also, in some aspects, arranging the order of the at least one data set may comprise arranging the order of the at least one data set in the set of registers.

At 1312, the GPU may store the at least one data set based on the arrangement of the order of the at least one data set, as described in connection with the examples in FIGS. 1-12. For example, as described in 1260 of FIG. 12, GPU 1202 may store the at least one data set based on the arrangement of the order of the at least one data set. Further, step 1312 may be performed by processing unit 120 in FIG. 1. In some aspects, storing the at least one data set may comprise storing the at least one data set in a memory (e.g., memory at a GPU, external memory, local memory, system memory, graphics memory (GMEM), texture memory, a buffer).

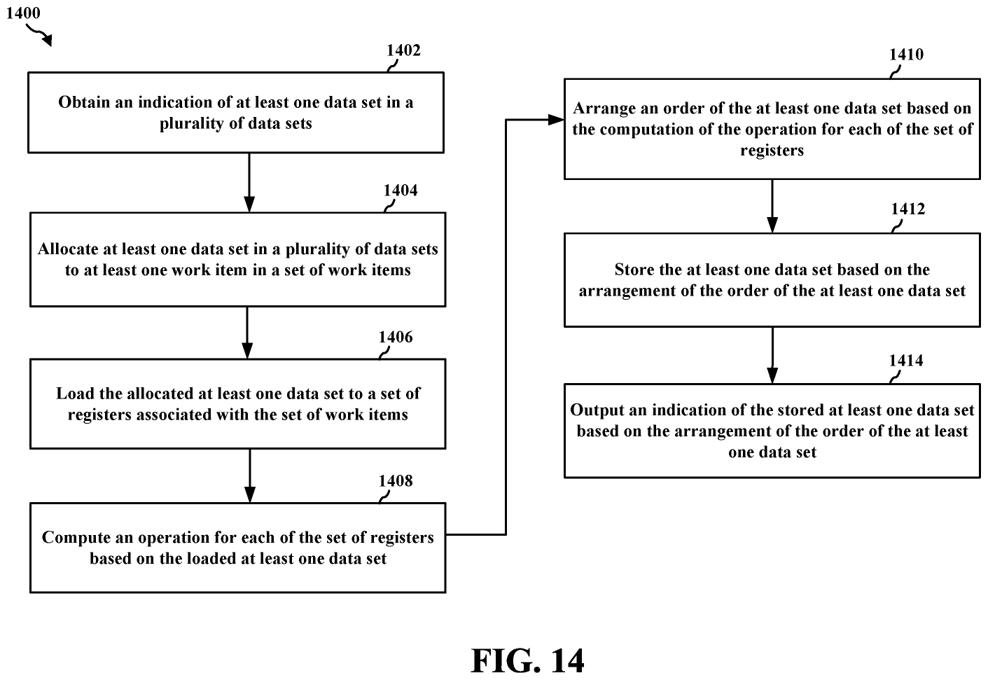

FIG. 14 is a flowchart 1400 of an example method of graphics processing in accordance with one or more techniques of this disclosure. The method may be performed by a GPU (e.g., a GPU, a cache at a GPU, a GPU component, another graphics processor, a CPU, a CPU component, or another central processor), a CPU (e.g., a CPU, a cache at a CPU, a CPU component, another central processor, a GPU, a GPU component, or another graphics processor), a display driver integrated circuit (DDIC), an apparatus for data or graphics processing, a wireless communication device, and/or any apparatus that may perform data or graphics processing as used in connection with the examples of FIGS. 1-12.

At 1402, the GPU may obtain an indication of the at least one data set in the plurality of data sets, where the allocation of the at least one data set may be based on the indication, as described in connection with the examples in FIGS. 1-12. For example, as described in 1210 of FIG. 12, GPU 1202 may obtain an indication of the at least one data set in the plurality of data sets, where the allocation of the at least one data set may be based on the indication. Further, step 1402 may be performed by processing unit 120 in FIG. 1. In some aspects, obtaining the indication of the at least one data set may comprise: receiving at least one input signal associated with the at least one data set; or obtaining the indication of the at least one input signal associated with the at least one data set.

At 1404, the GPU may allocate at least one data set in a plurality of data sets to at least one work item in a set of work items, as described in connection with the examples in FIGS. 1-12. For example, as described in 1220 of FIG. 12, GPU 1202 may allocate at least one data set in a plurality of data sets to at least one work item in a set of work items. Further, step 1404 may be performed by processing unit 120 in FIG. 1. In some aspects, allocating the at least one data set to the at least one work item may comprise: performing a one-to-one mapping of the at least one data set to the at least one work item. Also, allocating the at least one data set to the at least one work item may comprise: selecting the at least one data set for the at least one work item; or dividing the at least one data set amongst the at least one work item. In some aspects, the plurality of data sets may comprise at least one of: a plurality of signals, a plurality of source signals, a plurality of radio detection and rangings (radars), or a plurality of light detection and rangings (lidars). Also, at least one of the plurality of signals, the plurality of source signals, the plurality of radars, or the plurality of lidars may correspond to one of: a time domain, a spatial domain, or a frequency domain. Further, each data set of the plurality of data sets may be associated with a source of one of the plurality of signals, the plurality of source signals, the plurality of radars, or the plurality of lidars. Moreover, each data set of the plurality of data sets may be a continuous data stream for at least one of the plurality of signals, the plurality of source signals, the plurality of radars, or the plurality of lidars. In some aspects, the set of work items may be included in a compute unit located in a graphics processing unit (GPU); and each work item of the set of work items may correspond to a lane of a single-instruction multiple-data (SIMD) unit.

At 1406, the GPU may load the allocated at least one data set to a set of registers associated with the set of work items, as described in connection with the examples in FIGS. 1-12. For example, as described in 1230 of FIG. 12, GPU 1202 may load the allocated at least one data set to a set of registers associated with the set of work items. Further, step 1406 may be performed by processing unit 120 in FIG. 1. In some aspects, loading the allocated at least one data set to the set of registers may comprise loading the allocated at least one data set to the set of registers in a linear fashion or in a contiguous data set. For instance, this may maximize a bandwidth of a GPU (e.g., a 32-bit bandwidth, a 64-bit bandwidth, a 128-bit bandwidth, or a 256-bit bandwidth).

At 1408, the GPU may compute an operation for each of the set of registers based on the loaded at least one data set, as described in connection with the examples in FIGS. 1-12. For example, as described in 1240 of FIG. 12, GPU 1202 may compute an operation for each of the set of registers based on the loaded at least one data set. Further, step 1408 may be performed by processing unit 120 in FIG. 1. In some aspects, computing the operation for each of the set of registers may comprise: computing a fast Fourier Transform (FFT) operation using a sequence of iterations for each of the set of registers. The FFT operation may include one or more of: at least one butterfly computation, or a scaling operation associated with a set of twiddle factors. Also, the sequence of iterations may include one or more of: a sequence of butterfly iterations, or at least one radix iteration (e.g., a Radix-2 iteration, a Radix-4 iteration, a Radix-7 iteration, a Radix-8 iteration, a Radix-16 iteration, a Radix-32 iteration, or a Radix-64 iteration).

At 1410, the GPU may arrange an order of the at least one data set based on the computation of the operation for each of the set of registers, as described in connection with the examples in FIGS. 1-12. For example, as described in 1250 of FIG. 12, GPU 1202 may arrange an order of the at least one data set based on the computation of the operation for each of the set of registers. Further, step 1410 may be performed by processing unit 120 in FIG. 1. In some aspects, arranging the order of the at least one data set may comprise: performing a bit reverse operation on the at least one data set if a length of the at least one data set is a power of two (2); or performing a bit manipulation on the at least one data set if a length of the at least one data set is not a power of two (2). Also, in some aspects, arranging the order of the at least one data set may comprise arranging the order of the at least one data set in the set of registers.

At 1412, the GPU may store the at least one data set based on the arrangement of the order of the at least one data set, as described in connection with the examples in FIGS. 1-12. For example, as described in 1260 of FIG. 12, GPU 1202 may store the at least one data set based on the arrangement of the order of the at least one data set. Further, step 1412 may be performed by processing unit 120 in FIG. 1. In some aspects, storing the at least one data set may comprise storing the at least one data set in a memory (e.g., memory at a GPU, external memory, local memory, system memory, graphics memory (GMEM), texture memory, a buffer).

At 1414, the GPU may output an indication of the stored at least one data set based on the arrangement of the order of the at least one data set, as described in connection with the examples in FIGS. 1-12. For example, as described in 1270 of FIG. 12, GPU 1202 may output an indication of the stored at least one data set based on the arrangement of the order of the at least one data set. Further, step 1414 may be performed by processing unit 120 in FIG. 1. In some aspects, outputting the indication of the stored at least one data set may comprise transmitting at least one output signal associated with the stored at least one data set (e.g., GPU 1202 may transmit indication 1272 to CPU/GPU 1204); or storing the indication of the at least one output signal associated with the stored at least one data set (e.g., GPU 1202 may store indication 1274 in memory 1206).

In configurations, a method or an apparatus for data or graphics processing is provided. The apparatus may be a GPU (or other graphics processor), a CPU (or other central processor), a DDIC, an apparatus for graphics processing, and/or some other processor that may perform data or graphics processing. In aspects, the apparatus may be the processing unit 120 within the device 104, or may be some other hardware within the device 104 or another device. The apparatus, e.g., processing unit 120, may include means for allocating at least one data set in a plurality of data sets to at least one work item in a set of work items. The apparatus, e.g., processing unit 120, may also include means for loading the allocated at least one data set to a set of registers associated with the set of work items. The apparatus, e.g., processing unit 120, may also include means for computing an operation for each of the set of registers based on the loaded at least one data set. The apparatus, e.g., processing unit 120, may also include means for arranging an order of the at least one data set based on the computation of the operation for each of the set of registers. The apparatus, e.g., processing unit 120, may also include means for storing the at least one data set based on the arrangement of the order of the at least one data set. The apparatus, e.g., processing unit 120, may also include means for obtaining an indication of the at least one data set in the plurality of data sets, where the allocation of the at least one data set is based on the indication. The apparatus, e.g., processing unit 120, may also include means for outputting an indication of the stored at least one data set based on the arrangement of the order of the at least one data set.

The subject matter described herein may be implemented to realize one or more benefits or advantages. For instance, the described graphics processing techniques may be used by a cache, a GPU, a CPU, a central processor, or some other processor that may perform graphics processing to implement the higher radix FFT techniques described herein. This may also be accomplished at a low cost compared to other graphics processing techniques. Moreover, the graphics processing techniques herein may improve or speed up graphics processing or execution. Further, the graphics processing techniques herein may improve resource or data utilization and/or resource efficiency. Additionally, aspects of the present disclosure may utilize higher radix FFT techniques in order to improve memory bandwidth efficiency and/or increase processing speed at a cache, a CPU, a GPU, or a DPU.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

In accordance with this disclosure, the term “or” may be interpreted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. By way of example, and not limitation, such computer-readable media may comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is an apparatus for graphics processing, including at least one memory and at least one processor coupled to the at least one memory and, based at least in part on information stored in the at least one memory, the at least one processor, individually or in any combination, is configured to: allocate at least one data set in a plurality of data sets to at least one work item in a set of work items; load the allocated at least one data set to a set of registers associated with the set of work items; compute an operation for each of the set of registers based on the loaded at least one data set; arrange an order of the at least one data set based on the computation of the operation for each of the set of registers; and store the at least one data set based on the arrangement of the order of the at least one data set.

Aspect 2 is the apparatus of aspect 1, wherein to compute the operation for each of the set of registers, the at least one processor, individually or in any combination, is configured to: compute a fast Fourier Transform (FFT) operation using a sequence of iterations for each of the set of registers.

Aspect 3 is the apparatus of aspect 2, wherein the FFT operation includes one or more of: at least one butterfly computation, or a scaling operation associated with a set of twiddle factors.

Aspect 4 is the apparatus of aspect 2, wherein the sequence of iterations includes one or more of: a sequence of butterfly iterations, or at least one radix iteration.

Aspect 5 is the apparatus of any of aspects 1 to 4, wherein the plurality of data sets comprises at least one of: a plurality of signals, a plurality of source signals, a plurality of radio detection and rangings (radars), or a plurality of light detection and rangings (lidars).

Aspect 6 is the apparatus of aspect 5, wherein at least one of the plurality of signals, the plurality of source signals, the plurality of radars, or the plurality of lidars corresponds to one of: a time domain, a spatial domain, or a frequency domain.

Aspect 7 is the apparatus of any of aspects 5 to 6, wherein each data set of the plurality of data sets is associated with a source of one of the plurality of signals, the plurality of source signals, the plurality of radars, or the plurality of lidars.

Aspect 8 is the apparatus of any of aspects 5 to 7, wherein each data set of the plurality of data sets is a continuous data stream for at least one of the plurality of signals, the plurality of source signals, the plurality of radars, or the plurality of lidars.

Aspect 9 is the apparatus of any of aspects 1 to 8, wherein to allocate the at least one data set to the at least one work item, the at least one processor, individually or in any combination, is configured to: perform a one-to-one mapping of the at least one data set to the at least one work item.

Aspect 10 is the apparatus of any of aspects 1 to 9, wherein to allocate the at least one data set to the at least one work item, the at least one processor, individually or in any combination, is configured to: select the at least one data set for the at least one work item; or divide the at least one data set amongst the at least one work item.

Aspect 11 is the apparatus of any of aspects 1 to 10, wherein to arrange the order of the at least one data set, the at least one processor, individually or in any combination, is configured to: perform a bit reverse operation on the at least one data set if a length of the at least one data set is a power of two (2); or perform a bit manipulation on the at least one data set if a length of the at least one data set is not a power of two (2).

Aspect 12 is the apparatus of any of aspects 1 to 11, wherein the at least one processor, individually or in any combination, is further configured to: obtain an indication of the at least one data set in the plurality of data sets, wherein the allocation of the at least one data set is based on the indication.

Aspect 13 is the apparatus of aspect 12, wherein to obtain the indication of the at least one data set, the at least one processor, individually or in any combination, is configured to: receive at least one input signal associated with the at least one data set; or obtain the indication of the at least one input signal associated with the at least one data set.

Aspect 14 is the apparatus of any of aspects 1 to 13, wherein to arrange the order of the at least one data set, the at least one processor, individually or in any combination, is configured to: arrange the order of the at least one data set in the set of registers; and wherein to store the at least one data set, the at least one processor, individually or in any combination, is configured to: store the at least one data set in a memory.

Aspect 15 is the apparatus of any of aspects 1 to 14, wherein the set of work items is included in a compute unit located in a graphics processing unit (GPU); and wherein each work item of the set of work items corresponds to a lane of a single-instruction multiple-data (SIMD) unit.

Aspect 16 is the apparatus of any of aspects 1 to 15, wherein to load the allocated at least one data set to the set of registers, the at least one processor, individually or in any combination, is configured to: load the allocated at least one data set to the set of registers in a linear fashion or in a contiguous data set.

Aspect 17 is the apparatus of any of aspects 1 to 16, wherein the at least one processor, individually or in any combination, is further configured to: output an indication of the stored at least one data set based on the arrangement of the order of the at least one data set.

Aspect 18 is the apparatus of aspect 17, wherein to output the indication of the stored at least one data set, the at least one processor, individually or in any combination, is configured to: transmit at least one output signal associated with the stored at least one data set; or store the indication of the at least one output signal associated with the stored at least one data set.

Aspect 19 is the apparatus of aspect 18, further including (i.e., comprising): at least one of an antenna or a transceiver coupled to the at least one processor, wherein to transmit the at least one output signal, the at least one processor is configured to: transmit, via at least one of the antenna or the transceiver, the at least one output signal.

Aspect 20 is a method of graphics processing for implementing any of aspects 1 to 19.

Aspect 21 is an apparatus for graphics processing including means for implementing any of aspects 1 to 19.

Aspect 22 is a computer-readable medium (e.g., a non-transitory computer-readable medium) storing computer executable code (e.g., code for graphics processing), the code when executed by at least one processor causes the at least one processor to implement any of aspects 1 to 19.

What is claimed is:

1. An apparatus for graphics processing, comprising:
at least one memory; and
at least one processor coupled to the at least one memory and, based at least in part on information stored in the at least one memory, the at least one processor, individually or in any combination, is configured to:
allocate at least one data set in a plurality of data sets to at least one work item in a set of work items;
load the allocated at least one data set to a set of registers associated with the set of work items;
compute an operation for each of the set of registers based on the loaded at least one data set;
arrange an order of the at least one data set based on the computation of the operation for each of the set of registers; and
store the at least one data set based on the arrangement of the order of the at least one data set.

2. The apparatus of claim 1, wherein to compute the operation for each of the set of registers, the at least one processor, individually or in any combination, is configured to:
compute a fast Fourier Transform (FFT) operation using a sequence of iterations for each of the set of registers.

3. The apparatus of claim 2, wherein the FFT operation includes one or more of:
at least one butterfly computation, or
a scaling operation associated with a set of twiddle factors.

4. The apparatus of claim 2, wherein the sequence of iterations includes one or more of:
a sequence of butterfly iterations, or
at least one radix iteration.

5. The apparatus of claim 1, wherein the plurality of data sets comprises at least one of:
a plurality of signals,
a plurality of source signals,
a plurality of radio detection and rangings (radars), or
a plurality of light detection and rangings (lidars).

6. The apparatus of claim 5, wherein at least one of the plurality of signals, the plurality of source signals, the plurality of radars, or the plurality of lidars corresponds to one of:
a time domain,
a spatial domain, or
a frequency domain.

7. The apparatus of claim 5, wherein each data set of the plurality of data sets is associated with a source of one of the plurality of signals, the plurality of source signals, the plurality of radars, or the plurality of lidars.

8. The apparatus of claim 5, wherein each data set of the plurality of data sets is a continuous data stream for at least one of the plurality of signals, the plurality of source signals, the plurality of radars, or the plurality of lidars.

9. The apparatus of claim 1, wherein to allocate the at least one data set to the at least one work item, the at least one processor, individually or in any combination, is configured to:
perform a one-to-one mapping of the at least one data set to the at least one work item.

10. The apparatus of claim 1, wherein to allocate the at least one data set to the at least one work item, the at least one processor, individually or in any combination, is configured to:
select the at least one data set for the at least one work item; or
divide the at least one data set amongst the at least one work item.

11. The apparatus of claim 1, wherein to arrange the order of the at least one data set, the at least one processor, individually or in any combination, is configured to:
perform a bit reverse operation on the at least one data set if a length of the at least one data set is a power of two (2); or
perform a bit manipulation on the at least one data set if the length of the at least one data set is not the power of two (2).

12. The apparatus of claim 1, wherein the at least one processor, individually or in any combination, is further configured to:
obtain an indication of the at least one data set in the plurality of data sets, wherein the allocation of the at least one data set is based on the indication.

13. The apparatus of claim 12, wherein to obtain the indication of the at least one data set, the at least one processor, individually or in any combination, is configured to:
receive at least one input signal associated with the at least one data set; or
obtain the indication of the at least one input signal associated with the at least one data set.

14. The apparatus of claim 1, wherein to arrange the order of the at least one data set, the at least one processor, individually or in any combination, is configured to: arrange the order of the at least one data set in the set of registers; and
wherein to store the at least one data set, the at least one processor, individually or in any combination, is configured to: store the at least one data set in a memory.

15. The apparatus of claim 1, wherein the set of work items is included in a compute unit located in a graphics processing unit (GPU); and
wherein each work item of the set of work items corresponds to a lane of a single-instruction multiple-data (SIMD) unit.

16. The apparatus of claim 1, wherein to load the allocated at least one data set to the set of registers, the at least one processor, individually or in any combination, is configured to:
load the allocated at least one data set to the set of registers in a linear fashion or in a contiguous data set.

17. The apparatus of claim 1, wherein the at least one processor, individually or in any combination, is further configured to:
output an indication of the stored at least one data set based on the arrangement of the order of the at least one data set.

18. The apparatus of claim 17, wherein to output the indication of the stored at least one data set, the at least one processor, individually or in any combination, is configured to:
transmit at least one output signal associated with the stored at least one data set; or
store the indication of the at least one output signal associated with the stored at least one data set.

19. A method of graphics processing, comprising:
allocating at least one data set in a plurality of data sets to at least one work item in a set of work items;
loading the allocated at least one data set to a set of registers associated with the set of work items;
computing an operation for each of the set of registers based on the loaded at least one data set;
arranging an order of the at least one data set based on the computation of the operation for each of the set of registers; and
storing the at least one data set based on the arrangement of the order of the at least one data set.

20. A computer-readable medium storing computer executable code for graphics processing, the code when executed by at least one processor causes the at least one processor to:
allocate at least one data set in a plurality of data sets to at least one work item in a set of work items;
load the allocated at least one data set to a set of registers associated with the set of work items;
compute an operation for each of the set of registers based on the loaded at least one data set;
arrange an order of the at least one data set based on the computation of the operation for each of the set of registers; and
store the at least one data set based on the arrangement of the order of the at least one data set.
